(19) United States
(12) Patent Application Publication
(10) Pub. No.: US 2024/0256788 A1
(43) Pub. Date: Aug. 1, 2024

(54) SYSTEMS AND METHODS FOR DIALOG MANAGEMENT

(71) Applicant: GENESYS CLOUD SERVICES, INC., MENLO PARK, CA (US)

(72) Inventors: MICHAEL ORR, BELFAST (GB); NICOLA BURNS, BELFAST (GB); FELIX IMMANUEL WYSS, INDIANAPOLIS, IN (US)

(73) Assignee: GENESYS CLOUD SERVICES, INC., MENLO PARK, CA (US)

(21) Appl. No.: 18/630,534

(22) Filed: Apr. 9, 2024

Related U.S. Application Data
(63) Continuation of application No. 17/100,192, filed on Nov. 20, 2020, now abandoned.

(51) Int. Cl. G06F 40/35; G06F 40/216; G06F 40/58; G06N 5/04; H04L 51/02

(52) U.S. Cl. CPC G06F 40/35; G06F 40/216; G06F 40/58; G06N 5/041; H04L 51/02

(57) ABSTRACT

A method is presented for selecting, by a dialog manager, a current path location of an instance of a task from a list of a plurality of scored intent hypotheses with distinct intents and different task paths, comprising the steps of: performing a first filtering of the list of the plurality of scored intent hypotheses to comprise hypotheses meeting a pre-determined threshold; from the first filtered list, determining an intent and a task path for each of the hypotheses meeting the pre-determined threshold, wherein each of the hypotheses meeting the pre-determined threshold have the same intent; determining a simplest distinct task path to each hypothesis and presenting each of the simplest distinct paths in a second list; performing a second filtering of the second list by selecting a single distinct path; and confirming the intent of the hypothesis and configuring the selected single path to the current path location.

### CLAIM OF PRIORITY AND CROSS REFERENCE TO RELATED APPLICATIONS

This application claims priority and claims the benefit of United States Provisional Patent Application 62/939,183, titled “REACTIVE BOT DIALOG MANAGER”, filed on Nov. 22, 2019, the specification of which is incorporated herein by reference. This application is related to U.S. Provisional Patent Application 62/938,951, titled “SYSTEM AND METHOD FOR MANAGING A DIALOG BETWEEN A CONTACT CENTER SYSTEM AND A USER THEREOF”, filed on Nov. 22, 2019, the specification of which is also incorporated herein by reference. This application is a continuation of U.S. patent application Ser. No. 17/100,192, titled “SYSTEMS AND METHODS FOR DIALOG MANAGEMENT”, filed on Nov. 20, 2020, the specification of which is incorporated herein by reference.

### BACKGROUND

The present invention generally relates to telecommunications systems and methods. More particularly, the present invention pertains to the operation of contact centers and the management of dialogs therein.

In a contact center environment, a dialog might typically comprise a conversation between two or more parties (e.g., customers, agents and/or systems) to resolve a problem, serve a request, or otherwise accomplish some task/achieve some goal. The conversation may be performed through a variety of media channels, such as voice, chat, desktop, web, etc., to name a few non-limiting examples. An engine may be used (i.e., a dialog engine) to understand the state of the dialog at every turn. Turns might comprise an event from any party to the conversation or interaction, such as a response or a question. The dialog engine may be further used to control the next action taken through the system to move the conversation towards the contact center or business' goal. The dialog engine comprises ‘conversational AI’, which further comprises making context aware decisions throughout the interaction with a customer in a natural language, multi-modal medium. Actions may be directed to parties in a variety of ways. For example, an action may be directed to a customer through a message in the channel for the dialog. In another example, an action may be directed to an agent through recommending responses directly to the agent or indirectly as a coaching tip or other assistive guide on the agent's desktop. In another example, an action may be directed to a system in the form of an information request or the execution of a reservation.

Dialog management systems for chat/voice bots generally fall into one of two categories: stochastic (i.e. utilizing machine-learning) or deterministic (rules-based). The stochastic approach can provide sophisticated conversational capabilities, such as context awareness and natural-sounding discourse markers, but it is very difficult to incorporate business logic into such a system, especially when the business rules change frequently. These bots can often appear to be ‘intelligent’ to the end user from a conversational point of view, but in the business self-service world they are suitable only for the most straightforward of transactions. Their underlying conversational models require a lot of data to train and, once trained, cannot be easily modified. The training is usually done using human-to-human conversations, and it is difficult to indicate where in these conversations business rules are being applied, and which parts of a given training conversation subsequently depend on those implicit business rules.

The deterministic approach, on the other hand, provides much more flexibility and freedom with regard to specifying the business logic aspect of the conversation but dialog management is limited, traditionally, to simple forms such as frame filling (i.e. once the end user's main intent is established, the system abandons its use of natural language understanding and, instead, asks for the remaining pieces of information using one-at-a-time). This approach often uses finite state machines (FSMs) to track the end user's progress through a pre-scripted dialog. Very complex business transactions can be scripted using this approach but, due to limitations with FSM scalability, interactions with these deterministic bots leave the end user with little ability to direct the conversation: it is not feasible to map transitions from each state onto every other possible state.

A dialog manager is presented herein which combines the conversational sophistication (e.g. context awareness) provided by a stochastic dialog manager with the flexibility and predictability (e.g. for incorporating business logic) provided by more traditional rules-based approaches.

### BRIEF DESCRIPTION OF THE INVENTION

In an embodiment, a method is presented for selecting, by a dialog manager, a current path location of an instance of a task from a list of a plurality of scored intent hypotheses with distinct intents and different task paths, the method comprising the steps of: performing a first filtering of the list of the plurality of scored intent hypotheses to comprise hypotheses meeting a pre-determined threshold; from the first filtered list, determining an intent and a task path for each of the hypotheses meeting the pre-determined threshold, wherein each of the hypotheses meeting the pre-determined threshold have the same intent; determining a simplest distinct task path to each hypothesis and presenting each of the simplest distinct paths in a second list; performing a second filtering of the second list by selecting a single distinct path; and confirming the intent of the hypothesis and configuring the selected single path to the current path location.

The plurality of scored intent hypotheses are determined by: passing input received from a conversation through a natural language understanding engine; determining a listing of possible intents, of which each of the possible intents have one or more associated slot values; associating a confidence value with each possible intent; scoring the confidence values by: configuring the natural language understanding engine with a listing of all available intents, retrieving stored information associated with historical conversations, from a memory of the dialog manager, for each new intent, increasing the confidence score for a possible intent that is: a child of a current intent, matching a recently completed task, or matching an on-hold task, and determining a separate score for each distinct task path to an intent, and producing the list of the plurality of scored intent hypotheses.

The stored information associated with historical conversations comprises one or more of: a path to the current task in an intent hierarchy; a list of paths to recently completed tasks; and a list of paths to tasks currently on-hold.

The stored information associated with historical conversations is used by the dialog manager to further refine confidence scores for each new intent at runtime.

The conversation may be between a human user and a bot.

The current path location comprises one of: staying with what was previously the current path location based on the conversation with the dialog manager; activating a child task of what was previously the current path location; re-opening a recently closed path; switching away from the previously current path; switching back to a previously on-hold path; and disambiguating between different paths to the same intent.

The disambiguation comprises applying a corresponding weight towards a path location that is one of: recently completed, on-hold, a partial match to the current path location, a full match to the current path location.

The disambiguation comprises examination of lowest non-common denominator partial path locations and presenting said path locations as a list to the user.

A method is also presented for managing confirmation of a new intent and multiple slot values at the same time, the method comprising the steps of: defining one or more trigger phrases and one or more confirmation prompts; triggering a phrase that includes one or more slots; selecting, by the dialog manager, the one or more confirmation prompts comprising slots that match those provided by a user; presenting the one or more confirmation prompts to the user; in response to the user answering the one or more confirmation prompts, mapping by the natural language understanding engine the user response to the new intent and slot values; simultaneously confirming, by the dialog manager, the new intent and slot values provided by the user; and determining whether the new intent is a task intent, wherein if it is determined that the new intent is a task intent, rejecting the original intent and slots and accepting the new intent and slots, otherwise, determining whether the new intent is a non-task intent, wherein if it is determined that the new intent is a non-task intent, accepting the original intent, otherwise, rejecting the original intent/slots and the new intent/slots.

The simultaneously confirming comprises the dialog manager selecting a confirmation prompt variation whose slots match those provided by the user.

An answer to the one or more confirmation prompts is mapped by the natural language understanding engine to the intent and slot values.

A context-switch message is provided to the user if the user triggers a different task intent during processing of the new intent.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention, and many of the attendant features and aspects thereof, will become more readily apparent as the invention becomes better understood by reference to the following detailed description when considered in conjunction with the accompanying drawings in which like reference symbols indicate like components, wherein:

FIG. 1 illustrates an embodiment of a schematic block diagram of a computing device in accordance with exemplary embodiments of the present invention and/or with which exemplary embodiments of the present invention may be enabled or practiced;

FIG. 2 illustrates an embodiment of a schematic block diagram of a communications infrastructure or contact center with which exemplary embodiments of the present invention may be enabled or practiced;

FIG. 3 illustrates an embodiment of a schematic block diagram showing further details of a chat server operating as part of the chat system;

FIG. 4 illustrates an embodiment of a schematic block diagram of a chat module;

FIG. 5 illustrates an embodiment of a schematic block diagram of an intent hierarchy.

FIG. 6 illustrates an embodiment of a process for execution of dialog turns by a dialog manager.

FIG. 7 illustrates an embodiment of a process for task path selection.

FIG. 8 illustrates an embodiment of a process for confirming intent and slots.

FIG. 9 illustrates an embodiment of a process for response flow.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily referring to the same embodiment or example. Further, particular features, structures or characteristics may be combined in any suitable combinations and/or sub-combinations in one or more embodiments or examples.

Embodiments of the present invention may be implemented as an apparatus, method, or computer program product. Accordingly, example embodiments may take the form of an entirely hardware embodiment, an entirely software embodiment (including firmware, resident software, micro-code, etc.), or an embodiment combining software and hardware aspects. In each case, the example embodiment may be generally referred to as a “module” or “system” or “method”. Further, example embodiments may take the form of a computer program product embodied in any tangible medium of expression having computer-usable program code embodied in the medium.

It will be further appreciated that the flowchart and block diagrams provided in the figures illustrate architecture, functionality, and operation of possible implementations of systems, methods, and computer program products according to example embodiments of the present invention. In this regard, each block in the flowchart or block diagrams may represent a module, segment, or portion of code, which comprises one or more executable instructions for implementing the specified logical functions. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

### Computing Device

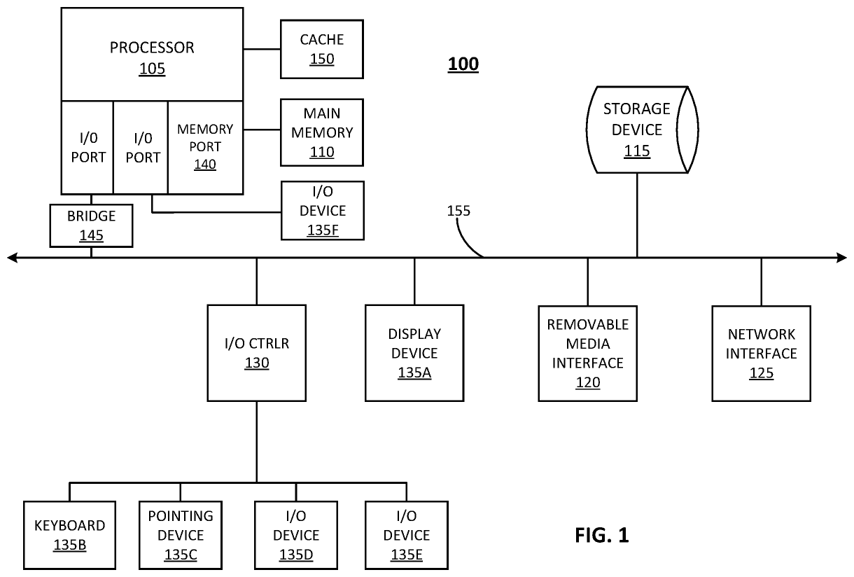

Turning now to FIG. 1, a schematic block diagram of an exemplary computing device 100 is shown in accordance with embodiments of the present invention and/or with which exemplary embodiments of the present invention may be enabled or practiced. Those skilled in the art will recognize that the various systems and methods disclosed herein may be computer implemented using many different forms of data processing equipment, for example, digital microprocessors and associated memory executing appropriate software programs. It should therefore be appreciated that FIG. 1 is provided as a non-limiting example.

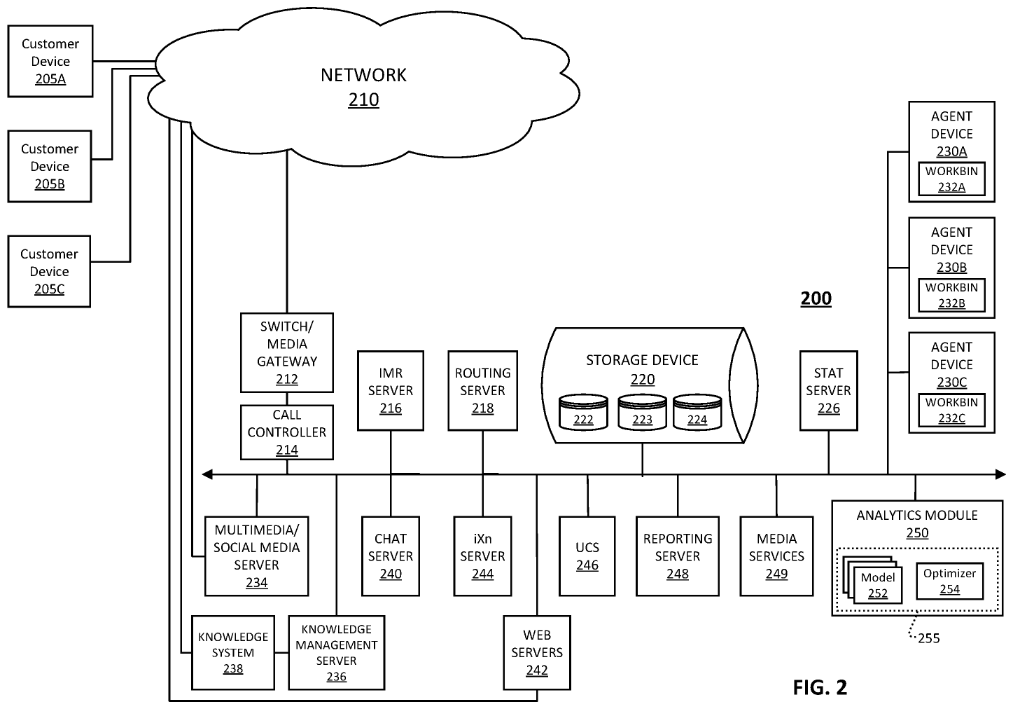

The computing device 100 may be implemented via firmware (e.g., an application-specific integrated circuit), hardware, or a combination of software, firmware, and hardware. It will be appreciated that each of the servers, controllers, switches, gateways, engines, and/or modules in the following figures (which collectively may be referred to as servers or modules) may be implemented via one or more of the computing devices 100. For example, the various servers may be a process or thread running on one or more processors of one or more computing devices 100, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 200 of FIG. 2—the various servers and computer devices thereof may be located on local computing devices 100 (i.e., on-site at the same physical location as the agents of the contact center), remote computing devices 100 (i.e., off-site or in a cloud-based or cloud computing environment, for example, in a remote data center connected via a network), or some combination thereof. In exemplary embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, or the like.

As shown in the illustrated example, the computing device 100 may include a central processing unit (CPU) or processor 105 and a main memory 110. The computing device 100 may also include a storage device 115, removable media interface 120, network interface 125, and one or more input/output (I/O) devices 135, which as depicted may include an I/O controller 130, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system and software that run on the computing device 100. The operating system may control scheduling tasks and access to system resources. Unless otherwise limited, the operating system and software may include any capable of performing the operations described herein, as would be appreciated by one of ordinary skill in the art.

As shown in the illustrated example, the computing device 100A may include a wide variety of I/O devices 135. As shown, a I/O controller 130 may be used to control one or more I/O devices. As shown, Input devices may include the keyboard 135B and pointing device 135C, which, for example, may be a mouse or optical pen. Output devices, for example, may include video display devices, speakers and printers. The I/O devices 135 and/or the I/O controller 130 may include suitable hardware and/or software for enabling for the use of multiple display devices. The computing device 100 may also support one or more removable media interfaces 120, such as a disk drive, USB port, or any other device suitable for reading data from or writing data to any type of computer readable media. The removable media interface 120, for example, may be used for installing software and programs.

The computing device 100 may be any workstation, desktop computer, laptop or notebook computer, server machine, virtual device, mobile telephone, smart phone, portable telecommunication device, media playing device, gaming system, mobile computing device, or any other type of computing, telecommunications or media device, without limitation, capable of performing the operations described herein. The computing device 100 may have several input devices with each having different processors and operating systems. The computing device 100 may include a mobile device that combines several devices, such as a mobile phone having a digital audio player or portable media player.

The computing device 100 may be one of a plurality of devices connected by a network or connect to other systems and resources via a network. As used herein, a network includes one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. As an example, a local machine may have the capacity to function as both a client node seeking access to resources provided by a server and as a server providing access to hosted resources for other clients. The network may be LAN or WAN links, broadband connections, wireless connections, or some combination thereof, with connections being established using appropriate communication protocols. The computing device 100 may communicate with other computing devices 100 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization are also contemplated, such as, for example, the network (e.g., via software defined networking) or functions (e.g., via network functions virtualization).

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and the like. In many cases this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; and analytics module 250. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C—it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VOIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment (e.g. Genesys® Designer).

In regard to the routing server 218, it may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices—represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VOIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C—it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferable activities. Once assigned to a particular agent, the deferable activity is pushed to that agent so that it appears on the agent device 230 of the selected agent. The deferable activity may appear in a workbin 232 as a task for the selected agent to complete. The functionality of the workbin 232 may be implemented via any conventional data structure, such as, for example, a linked list, array, etc. Each of the agent devices 230 may include a workbin 232, with the workbins 232A, 232B, and 232C being maintained in the agent devices 230A, 230B, and 230C, respectively. As an example, a workbin 232 may be maintained in the buffer memory of the corresponding agent device 230.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems and methods for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed more below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Chat Systems

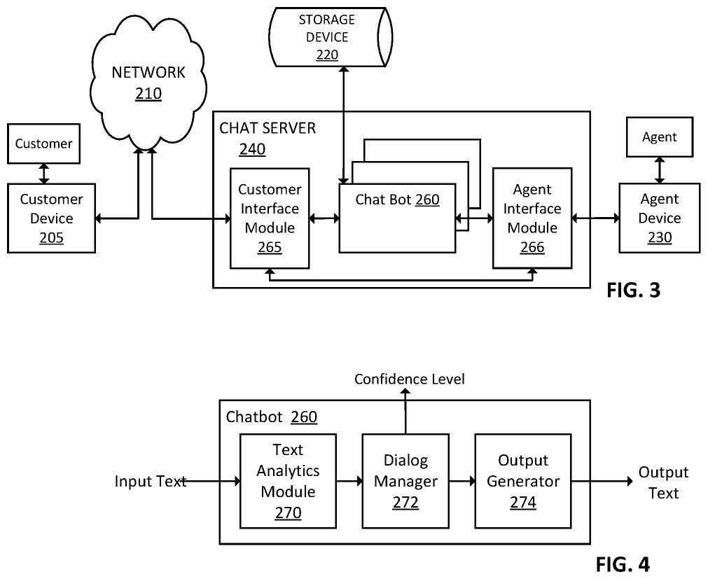

Turning to FIGS. 3 and 4, various aspects of chat systems and chatbots are shown. As will be seen, present embodiments may include or be enabled by such chat features, which, in general, enable the exchange of text messages between different parties. Those parties may include live persons, such as customers and agents, as well as automated processes, such as bots or chatbots.

By way of background, a bot (also known as an “Internet bot”) is a software application that runs automated tasks or scripts over the Internet. Typically, bots perform tasks that are both simple and structurally repetitive at a much higher rate than would be possible for a person. A ‘bot author’ refers to a person who constructs and/or manages the bots. A chatbot is a particular type of bot and, as used herein, is defined as a piece of software and/or hardware that conducts a conversation via auditory or textual methods. As will be appreciated, chatbots are often designed to convincingly simulate how a human would behave as a conversational partner. Chatbots are typically used in dialog systems for various practical purposes including customer service or information acquisition. Some chatbots use sophisticated natural language processing systems, while simpler ones scan for keywords within the input and then select a reply from a database based on matching keywords or wording pattern.

Before proceeding further with the description of the present invention, an explanatory note will be provided in regard to referencing system components—e.g., modules, servers, and other components—that have already been introduced in any previous figure. Whether or not the subsequent reference includes the corresponding numerical identifiers used in the previous figures, it should be understood that the reference incorporates the example described in the previous figures and, unless otherwise specifically limited, may be implemented in accordance with either that examples or other conventional technology capable of fulfilling the desired functionality, as would be understood by one of ordinary skill in the art. Thus, for example, subsequent mention of a “contact center system” should be understood as referring to the exemplary “contact center system 200” of FIG. 2 and/or other conventional technologies for implementing a contact center system. As additional examples, a subsequent mention below to a “customer device”, “agent device”, “chat server”, or “computing device” should be understood as referring to the exemplary “customer device 205”, “agent device 230”, “chat server 240”, or “computing device 200”, respectively, of FIGS. 1-2, as well as conventional technology for fulfilling the same functionality.

Chat features and chatbots will now be discussed in greater specificity with reference to the exemplary embodiments of a chat server and chatbot depicted, respectively, in FIGS. 3 and 4. While these examples are provided with respect to chat systems implemented on the contact center-side, such chat systems may be used on the customer-side of an interaction. Thus, it should be understood that the exemplary chat systems of FIGS. 3 and 4 may be modified for analogous customer-side implementation, including the use of customer-side chatbots configured to interact with agents and chatbots of contact centers on a customer's behalf. It should further be understood that chat features may be utilized by voice communications via converting text-to-speech and/or speech-to-text.

Referring specifically now to FIG. 3, a more detailed block diagram is provided of a chat server 240, which may be used to implement chat systems and features. The chat server 240 may be coupled to (i.e., in electronic communication with) a customer device 205 operated by the customer over a data communications network 210. The chat server 240, for example, may be operated by a enterprise as part of a contact center for implementing and orchestrating chat conversations with the customers, including both automated chats and chats with human agents. In regard to automated chats, the chat server 240 may host chat automation modules or chatbots 260A-260C (collectively referenced as 260), which are configured with computer program instructions for engaging in chat conversations. Thus, generally, the chat server 240 implements chat functionality, including the exchange of text-based or chat communications between a customer device 205 and an agent device 230 or a chatbot 260. As discussed more below, the chat server 240 may include a customer interface module 265 and agent interface module 266 for generating particular UIs at the customer device 205 and the agent device 230, respectively, that facilitate chat functionality.

In regard to the chatbots 260, each can operate as an executable program that is launched according to demand. For example, the chat server 240 may operate as an execution engine for the chatbots 260, analogous to loading VoiceXML files to a media server for interactive voice response (IVR) functionality. Loading and unloading may be controlled by the chat server 240, analogous to how a VoiceXML script may be controlled in the context of an interactive voice response. The chat server 240 may further provide a means for capturing and collecting customer data in a unified way, similar to customer data capturing in the context of IVR. Such data can be stored, shared, and utilized in a subsequent conversation, whether with the same chatbot, a different chatbot, an agent chat, or even a different media type. In example embodiments, the chat server 240 is configured to orchestrate the sharing of data among the various chatbots 260 as interactions are transferred or transitioned over from one chatbot to another or from one chatbot to a human agent. The data captured during interaction with a particular chatbot may be transferred along with a request to invoke a second chatbot or human agent.

In exemplary embodiments, the number of chatbots 260 may vary according to the design and function of the chat server 240 and is not limited to the number illustrated in FIG. 3. Further, different chatbots may be created to have different profiles, which can then be selected between to match the subject matter of a particular chat or a particular customer. For example, the profile of a particular chatbot may include expertise for helping a customer on a particular subject or communication style aimed at a certain customer preference. More specifically, one chatbot may be designed to engage in a first topic of communication (e.g., opening a new account with the business), while another chatbot may be designed to engage in a second topic of communication (e.g., technical support for a product or service provided by the business). Or, chatbots may be configured to utilize different dialects or slang or have different personality traits or characteristics. Engaging chatbots with profiles that are catered to specific types of customers may enable more effective communication and results. The chatbot profiles may be selected based on information known about the other party, such as demographic information, interaction history, or data available on social media. The chat server 240 may host a default chatbot that is invoked if there is insufficient information about the customer to invoke a more specialized chatbot. Optionally, the different chatbots may be customer selectable. In exemplary embodiments, profiles of chatbots 260 may be stored in a profile database hosted in the storage device 220. Such profiles may include the chatbot's personality, demographics, areas of expertise, and the like.

The customer interface module 265 and agent interface module 266 may be configured to generating user interfaces (UIs) for display on the customer device 205 that facilitate chat communications between the customer and a chatbot 260 or human agent. Likewise, an agent interface module 266 may generate particular UIs on the agent device 230 that facilitate chat communications between an agent operating an agent device 230 and the customer. The agent interface module 266 may also generate UIs on an agent device 230 that allow an agent to monitor aspects of an ongoing chat between a chatbot 260 and a customer. For example, the customer interface module 265 may transmit signals to the customer device 205 during a chat session that are configured to generated particular UIs on the customer device 205, which may include the display of the text messages being sent from the chatbot 260 or human agent as well as other non-text graphics that are intended to accompany the text messages, such as emoticons or animations. Similarly, the agent interface module 266 may transmit signals to the agent device 230 during a chat session that are configured to generated UIs on the agent device 230. Such UIs may include an interface that facilitates the agent selection of non-text graphics for accompanying outgoing text messages to customers.

In exemplary embodiments, the chat server 240 may be implemented in a layered architecture, with a media layer, a media control layer, and the chatbots executed by way of the IMR server 216 (similar to executing a VoiceXML on an IVR media server). As described above, the chat server 240 may be configured to interact with the knowledge management server 234 to query the server for knowledge information. The query, for example, may be based on a question received from the customer during a chat. Responses received from the knowledge management server 234 may then be provided to the customer as part of a chat response.

Referring specifically now to FIG. 4, a block diagram is provided of an exemplary chat automation module or chatbot 260. As illustrated, the chatbot 260 may include several modules, including a text analytics module 270, dialog manager 272, and output generator 274. The text analytics module 270 may be configured to analyze and understand natural language. In this regard, the text analytics module may be configured with a lexicon of the language, syntactic/semantic parser, and grammar rules for breaking a phrase provided by the customer device 205 into an internal syntactic and semantic representation. The configuration of the text analytics module depends on the particular profile associated with the chatbot. For example, certain words may be included in the lexicon for one chatbot but excluded that of another.

The dialog manager 272 receives the syntactic and semantic representation from the text analytics module 270 and manages the general flow of the conversation based on a set of decision rules. In this regard, the dialog manager 272 maintains a history and state of the conversation and, based on those, generates an outbound communication. The communication may follow the script of a particular conversation path selected by the dialog manager 272. As described in further detail below, the conversation path may be selected based on an understanding of a particular purpose or topic of the conversation. The script for the conversation path may be generated using any of various languages and frameworks conventional in the art, such as, for example, artificial intelligence markup language (AIML), SCXML, or the like.

During the chat conversation, the dialog manager 272 selects a response deemed to be appropriate at the particular point of the conversation flow/script and outputs the response to the output generator 274. In exemplary embodiments, the dialog manager 272 may also be configured to compute a confidence level for the selected response and provide the confidence level to the agent device 230. Every segment, step, or input in a chat communication may have a corresponding list of possible responses. Responses may be categorized based on topics (determined using a suitable text analytics and topic detection scheme) and suggested next actions are assigned. Actions may include, for example, responses with answers, additional questions, transfer to a human agent to assist, and the like. The confidence level may be utilized to assist the system with deciding whether the detection, analysis, and response to the customer input is appropriate or whether a human agent should be involved. For example, a threshold confidence level may be assigned to invoke human agent intervention based on one or more business rules. In exemplary embodiments, confidence level may be determined based on customer feedback. As described, the response selected by the dialog manager 272 may include information provided by the knowledge management server 234.

In exemplary embodiments, the output generator 274 takes the semantic representation of the response provided by the dialog manager 272, maps the response to a chatbot profile or personality (e.g., by adjusting the language of the response according to the dialect, vocabulary, or personality of the chatbot), and outputs an output text to be displayed at the customer device 205. The output text may be intentionally presented such that the customer interacting with a chatbot is unaware that it is interacting with an automated process as opposed to a human agent.

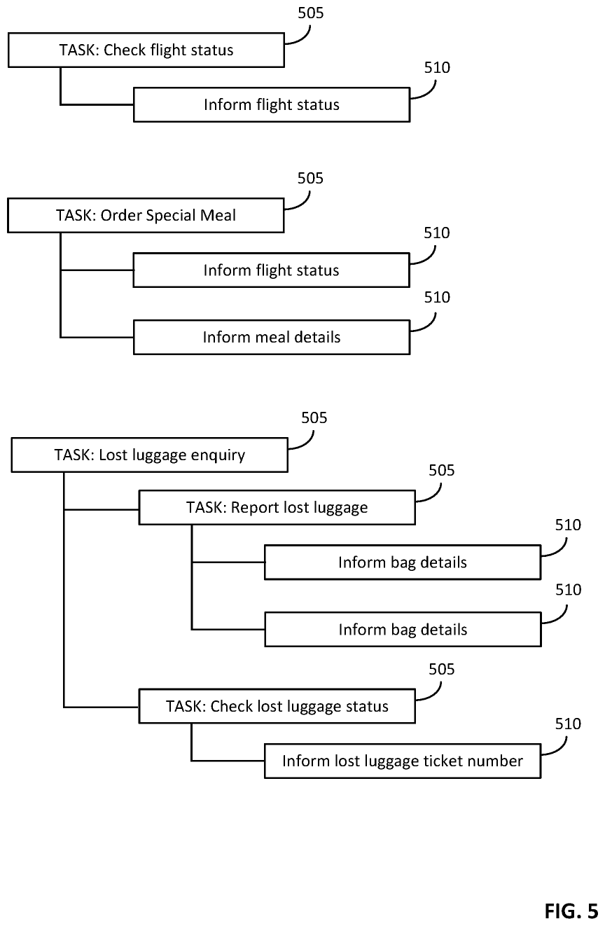

FIG. 5 illustrates an embodiment of an intent hierarchy. Turning to the dialog manager 272, a bot author may define a hierarchical list of all possible user intents, including intents for tasks (e.g. “I want to order a vegetarian meal”) and intents for other dialog acts such as informing new slot values (e.g. “it's for my flight to Denver next Thursday”). For example, in the hierarchical list indicated in FIG. 5, the “task: Order special meal” 505a may be associated with the phrase “I want to order a vegetarian meal”. A response 510 is associated with a task 505 through mapping by the bot author. The bot author may map some or all of the intents in the hierarchy to ‘response flows’. These response flows use a flowchart-like design to describe the logic for what to do next given the current state of the conversation. If the same intent is active on subsequent dialog turns, then the same flowchart re-executes from its start. Thus, the bot can be programmed to react appropriately to any new intent and/or slot values at any point in the conversation, a task that would not be feasible using traditional FSM-based approaches.

At runtime, the dialog manager 272 follows the end user's current position in the hierarchical list of intents and uses that position along with knowledge of recently-completed and on-hold intents to refine the confidence scores for each new intent, and thus makes a decision about whether to perform confirmation or disambiguation of what it deems to be the most likely intent.

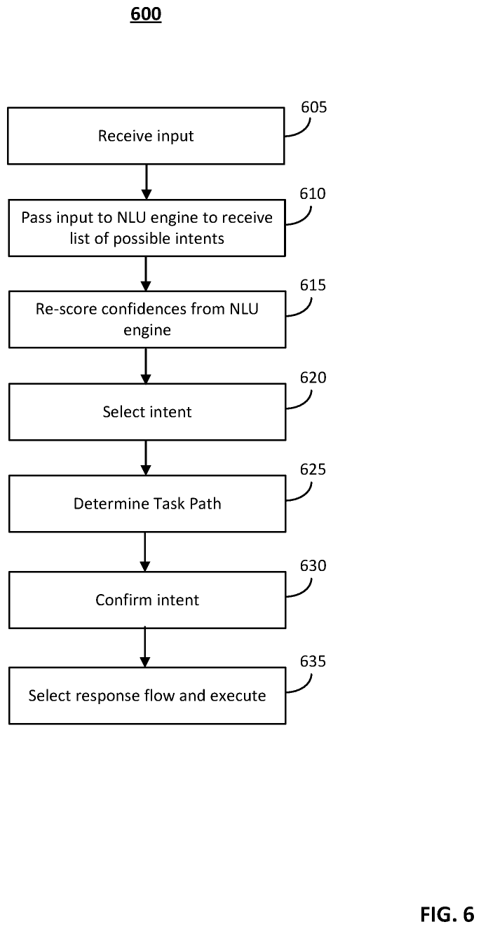

FIG. 6 illustrates an embodiment of a process for execution of dialog turns by a dialog manager, indicated generally at 600. The process 600 occurs in the dialog manager 272.

In operation 605, input is received. For example, input in the course of a conversation between a user and a bot is received through, for example, either typed text, or it may be the result of a transcription of spoken language by an automatic speech recognition system. The input is passed to a Natural Language Understanding (NLU) engine 610. The NLU engine may determine a listing of possible intents, of which each of the possible intents might include one or more slot values. This list is passed to the dialog manager. In an embodiment, each intent may have an associated confidence returned with it.

In operation 615, context-aware re-scoring of the NLU confidences is applied to the possible intents. In the course of re-scoring, weights may be added to the confidences. For example, intents hypothesized to be related to tasks on which the user has been working recently will have their associated confidence levels increased accordingly. The process of re-scoring of the NLU confidences based on current context may be performed as follows. The NLU engine (which may be a third-party engine) is configured with a flat list of all available intents. The engine has no understanding of the context of the current conversation. Within the dialog manager's memory, the following information may be stored for each session: the path to the currently-active task in the intent hierarchy; a list of task paths to ‘recently-completed’ tasks, including details about when they were completed; and a list of paths to tasks which are currently ‘on-hold’ (for example, the user originally activated the task but then switched to a different task, so the first task was put on-hold), including details about when they were pure on-hold.

When a new intent is detected, its confidence score may be increased in plurality of situations, including: that intent is a child of the current task intent (according to the intent hierarchy) or if the intent matches a task (or the child of a task) in the ‘recently-completed’ or ‘on-hold’ task lists. In an embodiment, the more recently the task was added to the list, the higher the increase of the new intent's confidence will be. Where the intent in question appears in multiple places in the intent hierarchy, a separate score may be determined for each distinct path to the intent, and these will be considered to be separate intent hypotheses in later processing.

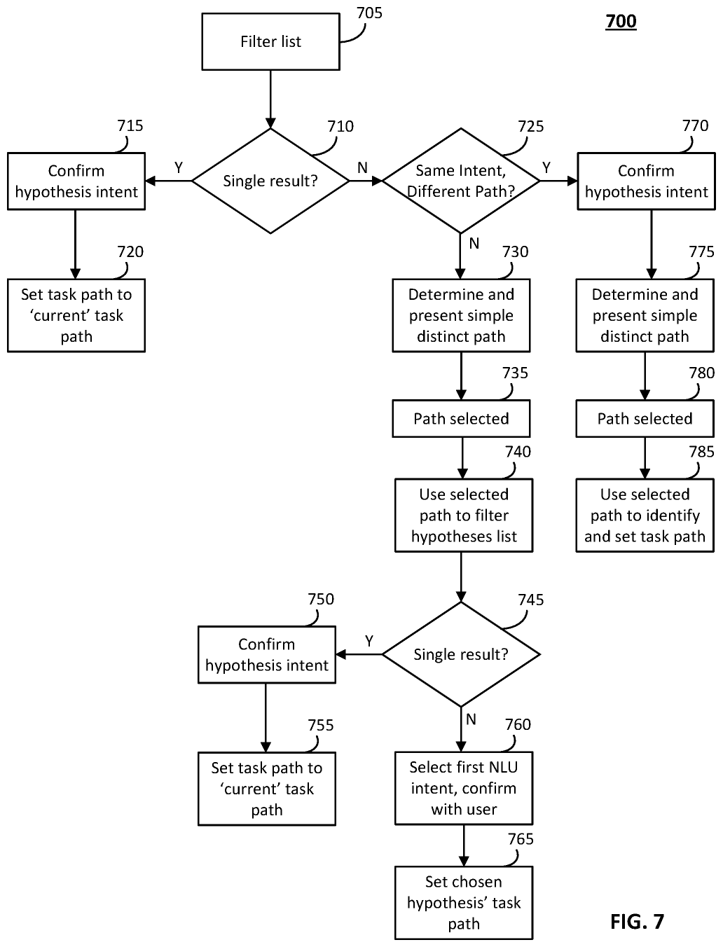

In operation 620, an intent is selected. It is then determined what the currently active task path should be in the intent hierarchy, based on the selected intent 625. In an embodiment, the same task intent may appear in multiple different places in the intent hierarchy. A ‘task path’ may describe the location of a single instance of that task intent in the hierarchy. The task path takes the form of a sequence of intent names, starting from the root of the hierarchy. The determination of the currently active task path may include any of the following: staying with what was previously the current task path based on the conversation with the dialog manager; activating a child task of what was previously the current task path; re-opening a ‘recently-closed’ task path; switching away from what was previously the current task path; switching back to a previously ‘on-hold’ task path; or disambiguating between different paths to the same intent. The process of determining the task path is described in greater detail in FIG. 7 below.

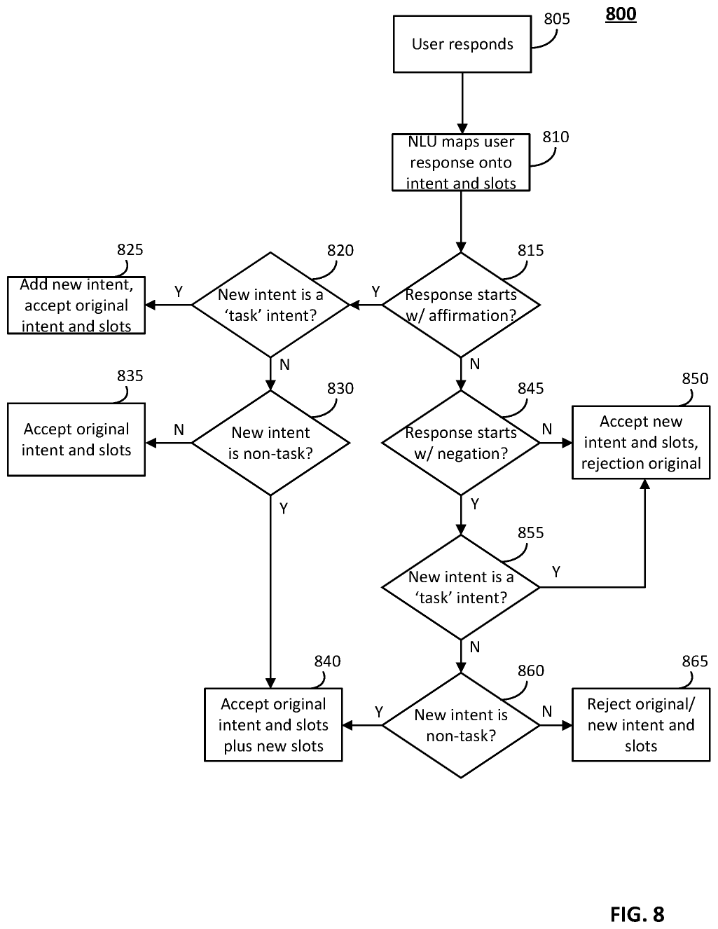

From the list of hypothesized intents, the highest scoring intent is confirmed 630. In an embodiment, this may be done directly with the user, or it may be based on heuristics or machine learning techniques. This process is described in greater detail in FIG. 8 below.

In operation 635, a response flow is selected for the active task path in the intent hierarchy and executed from the beginning. In an embodiment, the response flow outputs channel-specific prompts, performs business logic, and stops when it needs to wait for new input from the user. If the currently active task does not have a response flow but has child tasks in the hierarchy, then the user can be prompted automatically to select which of the child tasks they wish to activate. If the user triggers a task which has no flow associated with it, and that task has multiple child tasks, then the system can present a list of those child tasks to the user so that the user can easily drill down into sub-tasks. The information to produce this menu system can be gleaned directly from the intent hierarchy, without the bot author having the configure any additional logic. An example comprises:
User: “I have a question about lost luggage”
System: “Which of these lost luggage tasks do you want: 1) Report lost luggage; or 2) Check lost luggage status’
User: “2”
System: “Ok, do you have your lost luggage ticket number?”

Turning back to the process of determining a task path, FIG. 7 illustrates an embodiment of a process for task path selection, indicated generally at 700. The process 700 may be executed by the dialog manager 272. The bot is able to handle different styles of user input (e.g, follow-on questions, disambiguation of similar intents in multiple places), using only the information inherent in the intent hierarchy. An example of follow-on questions is illustrated as: User: “What time does flight GA100 land?”
System: (Starting the ‘flight_status’ task) “Flight GA100 lands at 8:24 pm.” (Moving ‘flight_status’ to ‘recently completed’ tasks lists.)
User: “what about flight GA101?”
System (Moving ‘flight_status’ back to ‘current’) “Flight GA101 lands at 10:40 pm.” (Moving ‘flight_status to ‘recently completed’ tasks list.) “Is there anything else I can help with?”

If the user subsequently triggers an intent that is a child of one of the completed task paths (and which is not a child of the current task path (if any)) then, assuming the confidence score is high enough, the system can move the task path from ‘recently-completed’ to ‘current’.

An example of disambiguation commonly occurs with generic intents (for example, “inform_flight_details”), which could be used in multiple different tasks (i.e. there are multiple matching task paths). If one of these task paths fully or partially matches what is the ‘current’ task path, or is in the list of ‘recently completed’ or ‘on-hold’ task paths, then the system will apply a corresponding weighting towards that task path. If there is still no clear choice, then the system can look at the lowest non-common denominator partial task paths and present those as a list of possible choices to the user in order to disambiguate.

When a list of re-scored intent hypotheses has been produced in the process 600, the bot performs the process 700. The list is filtered 705 to include only the highest-scoring hypotheses, or those which satisfy a specified threshold. It is determined whether there is only one hypothesis remaining out of the filtered list 710. If it is determined that there is only one hypothesis remaining, the hypthesis' NLU intent is confirmed 715. In an embodiment, the confirmation is performed by the user. The hypothesis' task path is set to be the ‘current’ task path 720, outputting a ‘context switch’ message to the user if appropriate. In an embodiment, when in the middle of processing for a task intent, if the user triggers a different task intent, the bot should make it clear to the end user that it is switching tasks (e.g. “OK, you want to check flight statuses. We can go back and finish ordering a special meal later.”). If the new task that the user triggered is a child of the current task path, according to the intent hierarchy, then the bot should not output any context-switch messages.

If it is determined that there is more than one hypothesis remaining, it is then determined whether the remaining hypotheses all use the same intent, but with different paths to that intent 725.

If it is determined that the hypotheses do not all use the same intent, the simplest distinct path to each hypothesis is calculated 730. The list of paths may be presented to the end user for disambiguation. The end user is presented with the paths and selects a path 735. The selected path is then used to further filter the list of hypotheses 740. It is then determined if there is only a single hypothesis remaining 745. If it is determined that a single hypothesis remains, the hypothesis' NLU intent is confirmed 750. In an embodiment, this may be done with the user. The hypothesis' task path is set to be the ‘current’ task path 755. If it is appropriate, a context switch message is output to the user, as previously described. If it is determined that single hypothesis does not remain, the first NLU intent is selected and confirmed with the user 760. If the user declines this intent, the next NLU intent is confirmed and so forth. The chosen hypothesis' task path is set to be the ‘current’ task path 765. If it is appropriate, a context switch message is output to the user, as previously described.

If it is determined in operation 725 that the hypotheses all use the same intent, but have different paths to that intent, the hypothesis-NLU intent is confirmed 770. In an embodiment, this may be confirmed with the user. The simplest distinct path to each hypothesis is then determined and presented to the end user for disambiguation 775. The end user selects one of these paths 780. The selected path is then used to identify the full task path and set to be the ‘current task path 785. If it is appropriate, a context switch message is output to the user, as previously described.

FIG. 8 illustrates an embodiment of a process for confirming intent and slots, indicated generally at 800. The process 800 comprises an algorithm to manage confirmation of an intent and multiple slot values at once, allowing users to: negate the entire intent and slots; accept the intent with some modified slots; select a different intent; or accept the intent and slots. This allows the user to use natural language to correct the system's interpretation of their inputs. A user can further confirm that the system received all the information that was provided through the input signals. Confirming the intent and all slots together also indicates that the bot does not later have to make business decisions based on potentially uncertain intents or slot values.

For each intent, the bot author defines one or more trigger phrases and one or more confirmation prompts. Trigger phrases may include placeholders for one or more slots, and at least one confirmation prompt variation should be configured for each combination of slots in the trigger phrases. When the user triggers a trigger phrase which includes one or more slots, the dialog manager will select the confirmation prompt variation whose slots match those provided by the user, thus it confirms both the intent and all of the slot values provided by the user at the same time.

In operation 805, the user responds to a confirmation prompt. The NLU engine maps the user response onto the intent and slots 810. It is determined whether the user response begins with an affirmation (e.g., “Yes” or “Yes but”) 815.

If it is determined that the user response begins with an affirmation (e.g., “Yes” or “Yes but”), it is further determined whether the new intent is a ‘task intent’ 820. If it is determined that new intent is a ‘task intent’, the new intent is added to the on-hold task list, and the original intent and original slots are accepted 825. If it is determined that new intent is not a ‘task intent’, it is further determined whether the new intent is a ‘non-task’ intent 830. If the new intent is not a non-task intent (e.g., ‘inform’), the original intent and slots are accepted 835. If the new intent is a non-task intent, then the original intent is accepted 840 and may additionally be confirmed with the user. Any new slots plus any of the original slots that were not provided in the new user input are also accepted.

If it is determined that the user response does not begin with an affirmation (e.g., “Yes” or “Yes but”), it is further determined whether the user response starts with negation (e.g. “No”) 845. If it is determined that the user response does not begin with negation, the original intent and slots are rejected 850 and the new intent and slots are accepted (these may additionally be confirmed with the user). If it is determined that the user response begins with negation, it is further determined whether the new intent is a ‘task intent’ 855. If it is determined that the new intent is a ‘task intent’, the original intent and slots are rejected 850 and the new intent and slots are accepted (these may additionally be confirmed with the user). If it is determined that the new intent is not a ‘task intent’, it is further determined whether the new intent is a non-task intent (e.g., ‘inform’) 860. If the new intent is a non-task intent, then the original intent is accepted 840 and may additionally be confirmed with the user. Any new slots plus any of the original slots that were not provided in the new user input are also accepted. If the new intent is not a non-task intent, the original intent/slots are rejected along with new intent/slots 865.

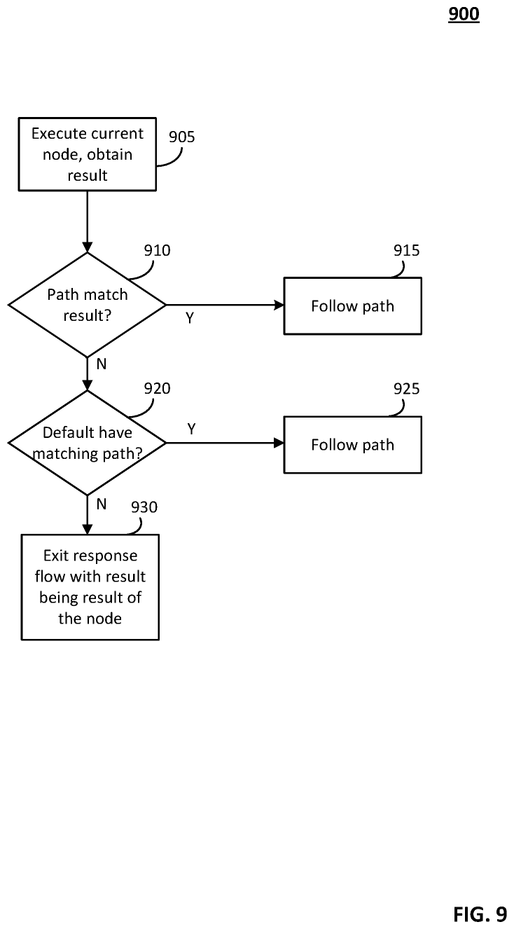

FIG. 9 illustrates an embodiment of a process for response flow, indicated generally at 900. A response flow comprises a modular construct consisting of a directed graph where each node in the graph performs some action and selects which named output path (or edge) to follow, and thus which node to visit next. Each response flow includes a special ‘default’ node which can also have paths going to other nodes on the graph. The ‘result’ of a node, which can be any arbitrary string, dictates which path will be followed in the graph. Results may have several parts, separated by dots. Any path that matches an initial substring of the result may be a match. For example, a path called “error.badfetch” will match results like “error.badfetch” and “error.badfetch.timeout”, but not simply “error”.

In operation 905, the current node is executed and its ‘result’ obtained. In operation 910, it is determined whether the current node has a path with the same name as the result obtained in operation 905. If it is determined that the current node has a path with the same name as the result, then the path is followed 915. If it is determined that the current node does not have a path with the same name as the result, it is further determined whether the ‘default’ node has a path with the same name as the result 920. If it is determined that the ‘default’ node has a path with the same name as the result, then the path is followed 925. If it is determined that the ‘default’ node does not have a path with the same name as the result, the response flow is exited 930. The result of the response flow is the result of the node. In an embodiment, the result of a Link node, which invoked the response flow will be the same as the current node's result.

An example of the configuration for a response flow is shown below in YAML format: nodes:

| | |
|---|---|
| - | node_name: Start |
| | node_type: Start |
| | output_paths: |
| | success: Ask number of widgets |
| - | node_name: Ask number of widgets |
| | node_type: AskForSlot |
| | slot_name: WidgetCount |
| | prompts: |
| | initial: “How many widgets would you like?” |
| | retry: “Sorry, tell me how many widgets you want to add to the order.” |
| | ... |
| | output_paths: |
| | success: Perform identification and verification |
| - | node_name: Perform identification and verification |
| | node_type: Link |
| | target_flow_id: 3829389 |
| | output_paths: |
| | success: Fulfill order |
| | error: Reset password |
| - | node_name: Reset password |
| | node_type: Link |
| | target_flow_id: 948494 |
| | output_paths: |
| | success: Perform identification and verification |
| - | node_name: Fulfill order |
| | node_type: Webhook |
| | url: https://www.genesys.com/widgets/orders |
| | method: POST |
| | fields: [AccountNumber, WidgetCout] |
| - | node_name: Handle error |
| | node_type: Say |
| | prompt: “Sorry, an error occurred. Please try again later.” |

default:
Output_paths:

error: Handle error

Nodes can query the context (including the list of active intents and slot values) and queue up output prompts to be displayed to the user. A node can also pause and await new input from the user if it needs to do so. Different types of customizable nodes may include some of the following examples. The “Say” type outputs a message for the user. The “Ask for Slot” type pauses until the configured slot has been filled by the user. The “logic” type performs custom logic and/or invokes a web service. The “Link” type may invoke another response flow and return the result to the current response flow. The “Return” type may finish execution of the response flow and return a given result to the response flow which invoked it. To prevent unwanted execution of any node, it can be configured with ‘memory’ such that if the node has already been executed successfully (on a current or previous turn), its execution will be skipped on subsequent visits and the same result as last is used. Memory may be dependent on certain named slot values such that execution of the node will be skipped unless the values of these slots have changed since the last time the node was fully executed.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

1. A method for selecting, by a dialog manager, a current path location of an instance of a task from a list of a plurality of scored intent hypotheses with distinct intents and different task paths, the method comprising the steps of:
a. performing a first filtering of the list of the plurality of scored intent hypotheses to comprise hypotheses meeting a pre-determined threshold;
b. from the first filtered list, determining an intent and a task path for each of the hypotheses meeting the pre-determined threshold, wherein each of the hypotheses meeting the pre-determined threshold have the same intent;
c. determining a simplest distinct task path to each hypothesis and presenting each of the simplest distinct paths in a second list;
d. performing a second filtering of the second list by selecting a single distinct path; and
e. confirming the intent of the hypothesis and configuring the selected single path to the current path location.

2. The method of claim 1, wherein the plurality of scored intent hypotheses are determined by:
a. passing input received from a conversation through a natural language understanding engine;
b. determining a listing of possible intents, of which each of the possible intents have one or more associated slot values;
c. associating a confidence value with each possible intent;
d. scoring the confidence values by:
i. configuring the natural language understanding engine with a listing of all available intents,
ii. retrieving stored information associated with historical conversations, from a memory of the dialog manager,
iii. for each new intent, increasing the confidence score for a possible intent that is: a child of a current intent, matching a recently completed task, or matching an on-hold task, and
iv. determining a separate score for each distinct task path to an intent, and
e. producing the list of the plurality of scored intent hypotheses.

3. The method of claim 2, wherein the stored information associated with historical conversations comprises one or more of:
a. a path to the current task in an intent hierarchy;
b. a list of paths to recently completed tasks; and
c. a list of paths to tasks currently on-hold.

4. The method of claim 3, wherein the stored information associated with historical conversations is used by the dialog manager to further refine confidence scores for each new intent at runtime.

5. The method of claim 2, wherein the conversation is between a human user and a bot.

6. The method of claim 1, wherein the current path location comprises one of:
a. staying with what was previously the current path location based on the conversation with the dialog manager;
b. activating a child task of what was previously the current path location;
c. re-opening a recently closed path;
d. switching away from the previously current path;
e. switching back to a previously on-hold path; and
f. disambiguating between different paths to the same intent.

7. The method of claim 6, wherein disambiguation comprises applying a corresponding weight towards a path location that is one of: recently completed, on-hold, a partial match to the current path location, a full match to the current path location.

8. The method of claim 6, wherein disambiguation comprises examination of lowest non-common denominator partial path locations and presenting said path locations as a list to the user.

9. A method for managing confirmation of a new intent and multiple slot values at the same time, the method comprising the steps of:
a. defining one or more trigger phrases and one or more confirmation prompts;
b. triggering a phrase that includes one or more slots;
c. selecting, by the dialog manager, the one or more confirmation prompts comprising slots that match those provided by a user;
d. presenting the one or more confirmation prompts to the user;
e. in response to the user answering the one or more confirmation prompts, mapping by the natural language understanding engine the user response to the new intent and slot values;
f. simultaneously confirming, by the dialog manager, the new intent and slot values provided by the user; and
g. determining whether the new intent is a task intent, wherein if it is determined that the new intent is a task intent, rejecting the original intent and slots and accepting the new intent and slots, otherwise, determining whether the new intent is a non-task intent, wherein if it is determined that the new intent is a non-task intent, accepting the original intent, otherwise, rejecting the original intent/slots and the new intent/slots.

10. The method of claim 9, wherein the simultaneously confirming comprises the dialog manager selecting a confirmation prompt variation whose slots match those provided by the user.

11. The method of claim 9, wherein an answer to the one or more confirmation prompts is mapped by the natural language understanding engine to the intent and slot values.

12. The method of claim 9, wherein a context-switch message is provided to the user if the user triggers a different task intent during processing of the new intent.
